(19) United States
(12) Patent Application Publication
(10) Pub. No.: US 2025/0233366 A1
(43) Pub. Date: Jul. 17, 2025

(54) ELECTRICAL CONNECTOR

(71) Applicant: CHENG UEI PRECISION INDUSTRY CO., LTD., New Taipei City (TW)

(72) Inventors: WAN-CHUN LIN, Dong-Guan City (CN); MING-GUI SUN, Dong-Guan City (CN); HSIN-MIN CHAO, New Taipei City (TW)

(21) Appl. No.: 18/817,207

(22) Filed: Aug. 27, 2024

(30) Foreign Application Priority Data
Jan. 16, 2024 (CN) 202420112148.3

(51) Int. Cl. H01R 13/652; H01R 13/436; H01R 13/516; H01R 13/655; H01R 13/6581

(52) U.S. Cl. CPC H01R 13/652; H01R 13/436; H01R 13/655; H01R 13/6581; H01R 13/516

(57) ABSTRACT

An electrical connector includes an insulation body, a terminal assembly, a middle grounding plate and two shielding plates. The terminal assembly is fastened in the insulation body. The terminal assembly has a base portion, and a plurality of terminals fastened in the base portion. The plurality of the terminals are arranged in two rows. The plurality of the terminals arranged in each row have two grounding terminals. Each grounding terminal has a fastening portion. A middle of the fastening portion is bent inward and frontward to form an arc portion. An outer surface of the arc portion extends outward, then is bent outward and extends outward to form a grounding foot. The middle grounding plate is mounted in a middle of the terminal assembly. The two shielding plates are disposed to an upper surface and a lower surface of the insulation body.

### CROSS REFERENCE TO RELATED APPLICATIONS

The present application is based on, and claims priority from, China Patent Application No. 202420112148.3, filed Jan. 16, 2024, the disclosure of which is hereby incorporated by reference herein in its entirety.

### BACKGROUND OF THE INVENTION

### Field of the Invention

The present invention generally relates to an electrical connector, and more particularly to an electrical connector which is capable of improving a plastic combining force and shaping a terminal conveniently.

### Description of Related Art

In various electrical connector types which are frequently used by various electronic products, universal serial bus (USB) connectors are the most widely applied connectors. With the improvement of sciences and technologies, more and more kinds of the universal serial bus connectors are developed, such as USB 2.0 connectors, USB 3.0 connectors, Micro USB connectors, Mini USB connectors or USB Type-C connectors. The USB Type-C connectors have been widely applied in the various electronic products.

A conventional electrical connector includes a middle grounding plate, an upper terminal assembly and a lower terminal assembly. The upper terminal assembly and the lower terminal assembly are disposed opposite to each other. The middle grounding plate is disposed between the upper terminal assembly and the lower terminal assembly. The upper terminal assembly has an upper grounding terminal. The upper grounding terminal has a first fastening portion, a first contacting portion and a first soldering portion. A front end of the first fastening portion extends frontward to form the first contacting portion. A rear end of the first fastening portion extends rearward to form the first soldering portion. The first fastening portion is formed between the first contacting portion and the first soldering portion. The first fastening portion has a first grounding portion and a connecting foot. The first grounding portion extends downward to form the connecting foot. The lower terminal assembly has a lower grounding terminal. The lower grounding terminal has a second fastening portion, a second contacting portion and a second soldering portion. A front end of the second fastening portion extends frontward to form the second contacting portion. A rear end of the second fastening portion extends rearward to form the second soldering portion. The second fastening portion is formed between the second contacting portion and the second soldering portion. The second fastening portion has a second grounding portion and a first grounding hole. The first grounding hole penetrates through a top surface and a bottom surface of the second grounding portion. The middle grounding plate has a third grounding portion and a second grounding hole. The second grounding hole penetrates through a top surface and a bottom surface of the third grounding portion. The second grounding hole is corresponding to the first grounding hole along an up-down direction. The connecting foot penetrates through the first grounding hole and the second grounding hole along the up-down direction, so the first grounding portion, the second grounding portion and the third grounding portion are connected by the connecting foot, and the first grounding portion, the second grounding portion and the third grounding portion are conductive.

However, when the conventional electrical connector is molded by an injection molding technology, the upper terminal assembly, the lower terminal assembly and an insulation body are easily short shot, so a combining force of the conventional electrical connector is insufficient. The conventional electrical connector has a risk of a poor contact in a usage process.

Thus, it is essential to provide an innovative electrical connector which is capable of improving a plastic combining force and shaping a terminal conveniently.

### BRIEF SUMMARY OF THE INVENTION

An object of the present invention is to provide an electrical connector which is capable of improving a plastic combining force and shaping a terminal conveniently. The electrical connector includes an insulation body, a terminal assembly, a middle grounding plate and two shielding plates. The terminal assembly is fastened in the insulation body. The terminal assembly has a base portion, and a plurality of terminals fastened in the base portion. The plurality of the terminals are arranged in two rows and along an up-down direction. The plurality of the terminals arranged in each row have two grounding terminals. Each grounding terminal has a fastening portion. A middle of the fastening portion of each grounding terminal is bent inward and frontward to form an arc portion. An outer surface of the arc portion extends outward, then is bent outward and extends outward to form a grounding foot. An outer surface of a junction between the arc portion and the fastening portion of each grounding terminal is recessed inward to form a notch. The notch of each grounding terminal is filled by the base portion. The middle grounding plate is mounted in a middle of the terminal assembly, and the terminal assembly and the middle grounding plate are fastened in the insulation body. Two opposite sides of a middle of the middle grounding plate extend outward to form two wings, respectively. The grounding feet of the grounding terminals of the terminal assembly are soldered to front ends of top surfaces and bottom surfaces of the two wings. The two shielding plates are disposed to an upper surface and a lower surface of the insulation body. Two opposite sides of a rear end of each shielding plate are bent inward to form two bending portions, respectively. Two opposite sides of the two bending portions extend outward to form two soldering plates, respectively. The soldering plates of the two shielding plates are soldered to rear ends of the top surfaces and the bottom surfaces of the two wings.

Another object of the present invention is to provide an electrical connector. The electrical connector includes an insulation body, a terminal assembly, a middle grounding plate and two shielding plates. The terminal assembly is fastened in the insulation body. The terminal assembly has a base portion, and a plurality of terminals fastened in the base portion. The plurality of the terminals are arranged in two rows and along an up-down direction. Two outer sides of the plurality of the terminals arranged in each row have two grounding terminals. Each grounding terminal has a fastening portion. A middle of the fastening portion of each grounding terminal is bent inward and frontward to form an arc portion. An outer surface of the arc portion extends outward, then is bent outward and extends outward to form a grounding foot. A junction between a front surface and an outer surface of the grounding foot has a chamfer slantwise extending rearward and outward. An outer surface of a junction between the arc portion and the fastening portion of each grounding terminal is recessed inward to form a notch. The notch of each grounding terminal is filled by the base portion. The middle grounding plate is mounted in a middle of the terminal assembly, and the terminal assembly and the middle grounding plate are fastened in the insulation body. Two opposite sides of a middle of the middle grounding plate extend outward to form two wings, respectively. The grounding feet of the grounding terminals of the terminal assembly are connected to front ends of top surfaces and bottom surfaces of the two wings. The two shielding plates are disposed to an upper surface and a lower surface of the insulation body. Two opposite sides of a rear end of each shielding plate are bent inward to form two bending portions, respectively. Two opposite sides of the two bending portions extend outward to form two soldering plates, respectively. The soldering plates of the two shielding plates are connected to rear ends of the top surfaces and the bottom surfaces of the two wings.

Another object of the present invention is to provide an electrical connector. The electrical connector includes an insulation body, an upper terminal assembly fastened in an upper portion of the insulation body, a lower terminal assembly fastened in a lower portion of the insulation body, a middle grounding plate and two shielding plates. The upper terminal assembly has a plurality of upper terminals and an upper base portion. The plurality of the upper terminals are fastened in the upper base portion. Two outer sides of the plurality of the upper terminals have two grounding terminals. The lower terminal assembly has a plurality of lower terminals and a lower base portion. The plurality of the lower terminals are fastened in the lower base portion. Two outer sides of the plurality of the lower terminals have the two grounding terminals. Each grounding terminal has a fastening portion. A middle of the fastening portion of each grounding terminal is bent inward and frontward to form an arc portion. An outer surface of the arc portion extends outward, then is bent outward and extends outward to form a grounding foot. An outer surface of a junction between the arc portion and the fastening portion of each grounding terminal is recessed inward to form a notch. The notches of the grounding terminals of the upper terminal assembly and the lower terminal assembly are filled by the upper base portion and the lower base portion. The middle grounding plate is disposed between the upper terminal assembly and the lower terminal assembly. The upper terminal assembly, the lower terminal assembly and the middle grounding plate are fastened in the insulation body. Two opposite sides of a middle of the middle grounding plate extend outward to form two wings, respectively. The grounding feet of the grounding terminals of the upper terminal assembly are soldered to front ends of top surfaces of the two wings, and the grounding feet of the grounding terminals of the lower terminal assembly are soldered to front ends of bottom surfaces of the two wings. The two shielding plates are disposed to an upper surface and a lower surface of the insulation body. Two opposite sides of a rear end of each shielding plate are bent inward to form two bending portions, respectively. Two opposite sides of the two bending portions extend outward to form two soldering plates, respectively. The soldering plates of the two shielding plates are soldered to rear ends of the top surfaces and the bottom surfaces of the two wings. Outer edges of the grounding feet of the grounding terminals of the upper terminal assembly and lower terminal assembly project beyond two outer edges of the two wings, and outer edges of the soldering plates of the two shielding plates project beyond the two outer edges of the two wings of the middle grounding plate.

As described above, the grounding feet of the grounding terminals of the terminal assembly are soldered to the front ends of the top surfaces and the bottom surfaces of the two wings of the middle grounding plate, and the soldering plates of the two shielding plates are soldered to the rear ends of the top surfaces and the bottom surfaces of the two wings of the middle grounding plate, so that a crosstalk interference of the electrical connector is improved. Furthermore, the arc portion facilitates a terminal shape formation of each grounding terminal of the terminal assembly, an inclining portion facilitates a terminal shape formation of each power terminal of the terminal assembly, and bending pieces of the signal terminals which are located between one grounding terminal and one power terminal facilitate terminal shape formations of the signal terminals which are located between the one grounding terminal and the one power terminal of the terminal assembly. In addition, the chamfer is used for increasing an area of a base body of the insulation body to avoid a short shot problem of the insulation body, and the notch is used for increasing an area of the base portion of the terminal assembly to avoid the short shot problem of the base portion of the terminal assembly. The indentation is filled by the insulation body to improve a plastic combining force. As a result, the electrical connector is capable of improving the plastic combining force, improving the crosstalk interference and shaping the terminal conveniently.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is a partially exploded view showing a glue body, an insulating housing, a metal shell assembly, two metal elements, and an insulation body together with the terminal assembly, the middle grounding plate and the two shielding plates of the electrical connector of FIG. 1;

FIG. 3 is another partially exploded view showing the insulation body, the two shielding plates, and the terminal assembly together with the middle grounding plate of the electrical connector of FIG. 2;

FIG. 4 is an enlarged view of an encircled portion IV of the electrical connector of FIG. 3;

FIG. 5 is an exploded view of an upper terminal assembly of the terminal assembly of the electrical connector of FIG. 2;

FIG. 6 is an enlarged view of an encircled portion VI of the upper terminal assembly of the electrical connector of FIG. 5;

FIG. 7 is an exploded view of a lower terminal assembly of the terminal assembly of the electrical connector of FIG. 2;

FIG. 8 is a partial assembling view of the electrical connector of FIG. 2;

FIG. 9 is a sectional view of the electrical connector along a line IX-IX of FIG. 8; and

FIG. 10 is another partial assembling view of the electrical connector of FIG. 2.

### DETAILED DESCRIPTION OF THE INVENTION

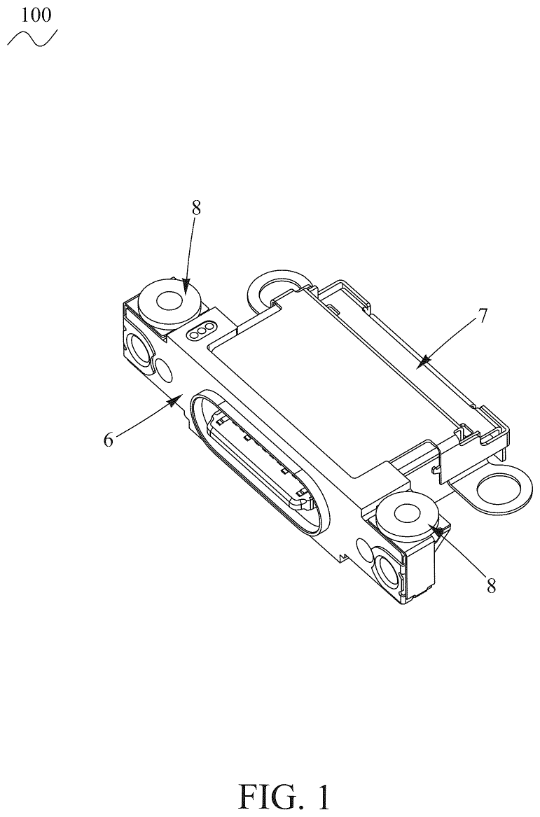

With reference to FIG. 1 to FIG. 3, an electrical connector 100 in accordance with the present invention is shown. The electrical connector 100 includes an insulation body 1, a terminal assembly 2, a middle grounding plate 3, two shielding plates 4, a glue body 5, an insulating housing 6, a metal shell assembly 7 and two metal elements 8. In the present invention, the electrical connector 100 is a USB (Universal Serial Bus) Type-C connector. In a concrete implementation, the electrical connector 100 is able to be another type connector which is different from the USB Type-C connector.

The terminal assembly 2 is fastened in the insulation body 1. The middle grounding plate 3 is mounted in a middle of the terminal assembly 2, and the terminal assembly 2 and the middle grounding plate 3 are fastened in the insulation body 1. The insulation body 1 surrounds the middle grounding plate 3 and the terminal assembly 2. The two shielding plates 4 are disposed to an upper surface and a lower surface of the insulation body 1. The insulation body 1 is fastened in the insulating housing 6. The metal shell assembly 7 are disposed to an upper surface and a lower surface of the insulating housing 6. The metal shell assembly 7 is used for being connected to ground and shielding an interference. The two metal elements 8 are disposed to two opposite sides of the insulating housing 6, respectively.

The glue body 5 surrounds a rear end of the insulation body 1. The glue body 5 is covered to a rear end of the insulating housing 6. The glue body 5 seals up an interval between the insulation body 1, the terminal assembly 2, the middle grounding plate 3 and the insulating housing 6, so that water is prevented from flowing into a rear end of the electrical connector 100, and the electrical connector 100 is prevented from being damaged due to a water infiltration of the electrical connector 100. The glue body 5 surrounds a part of the terminal assembly 2 and a part of the middle grounding plate 3.

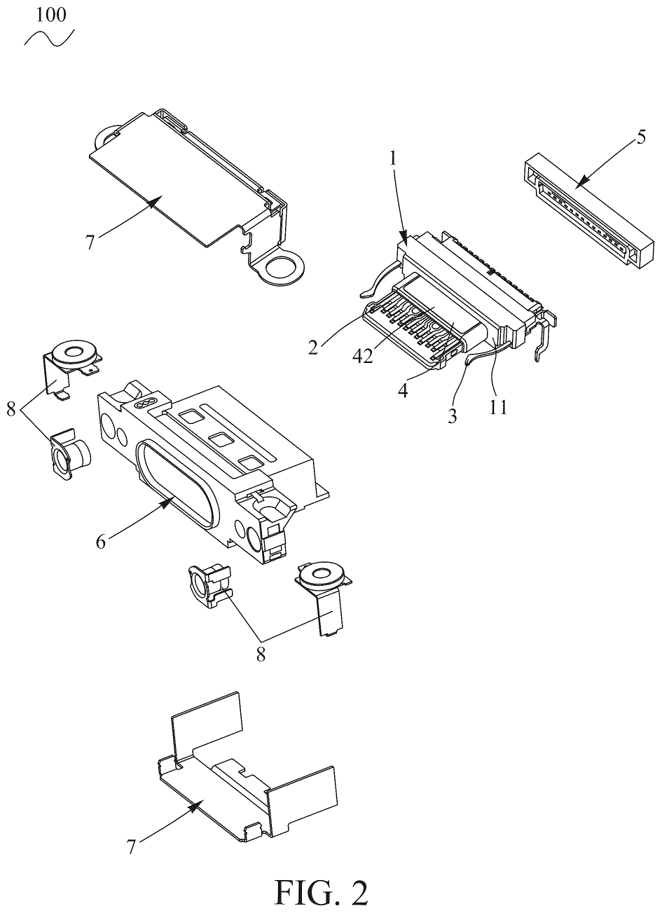

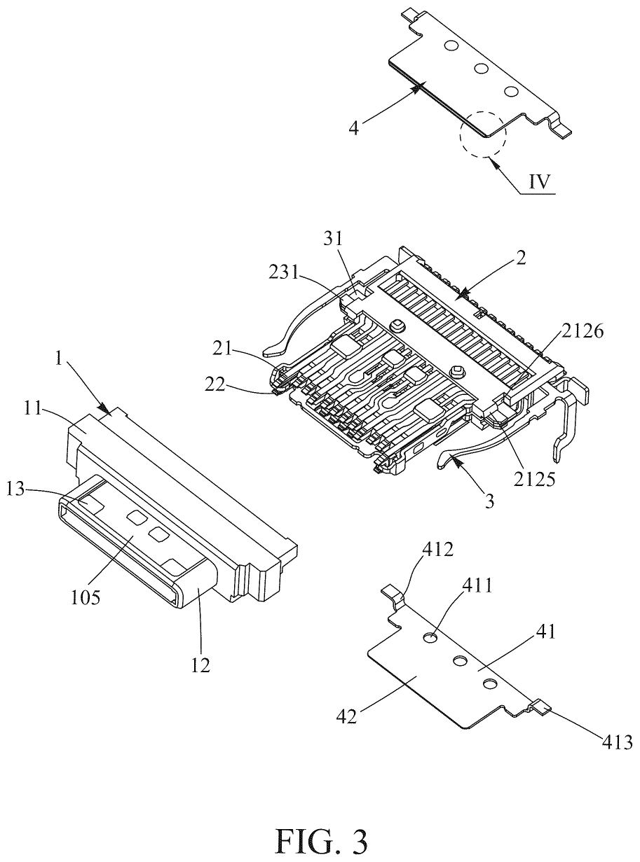

Referring to FIG. 2 and FIG. 3, the insulation body 1 has a base body 11, an enclosing portion 12 and a plurality of through holes 13. A middle of a front surface of the base body 11 extends frontward to form the enclosing portion 12. The base body 11 and the enclosing portion 12 are shown as hollow structures. The plurality of the through holes 13 penetrate through a top surface and a bottom surface of the enclosing portion 12. The plurality of the through holes 13 are disposed at the top surface and the bottom surface of the enclosing portion 12. Corresponding mechanisms of the terminal assembly 2 are disposed in the plurality of the through holes 13. When the insulation body 1 is formed, the corresponding mechanisms of the terminal assembly 2 are used for supporting corresponding mechanisms of the two shielding plates 4 to avoid an encapsulation problem of the two shielding plates 4.

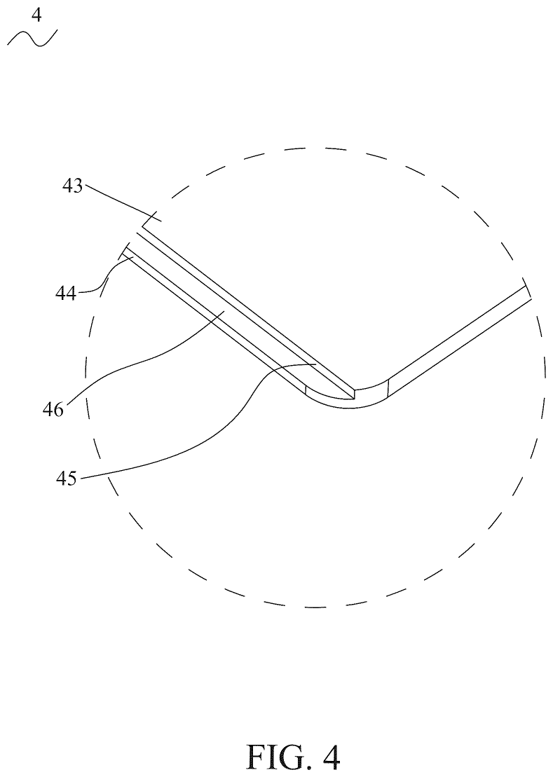

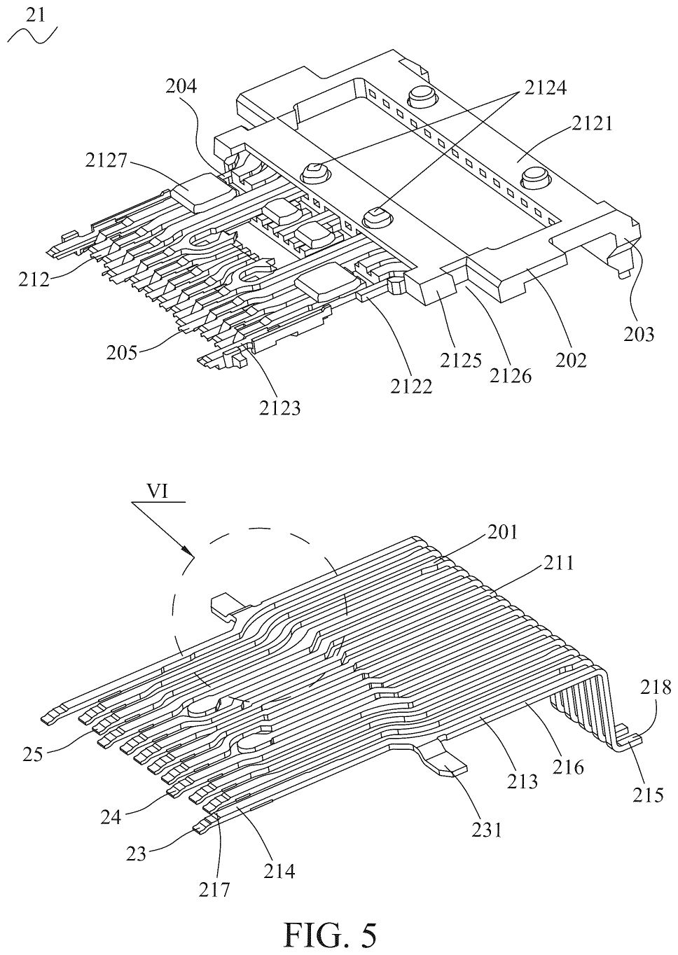

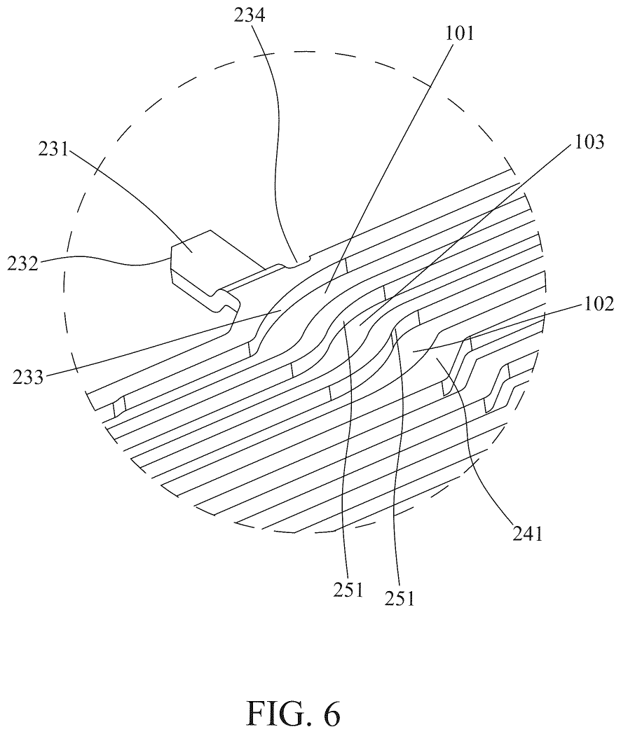

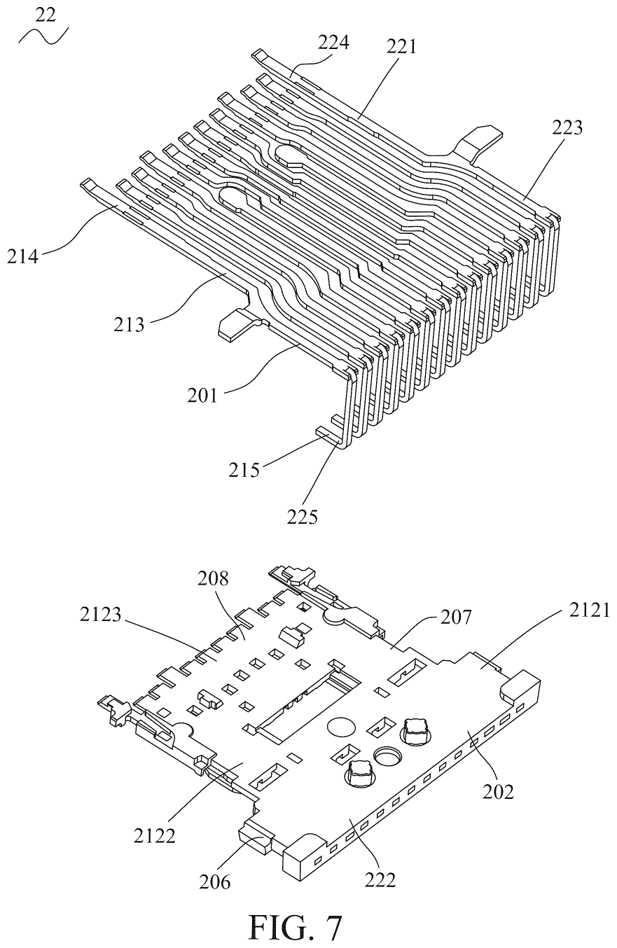

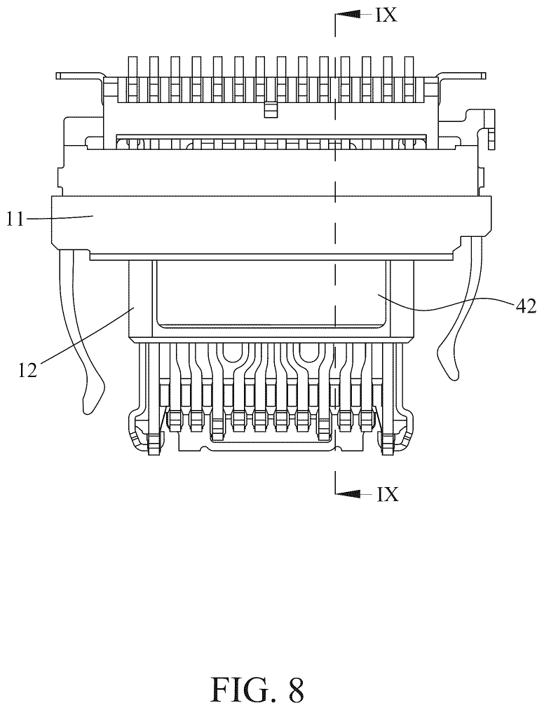

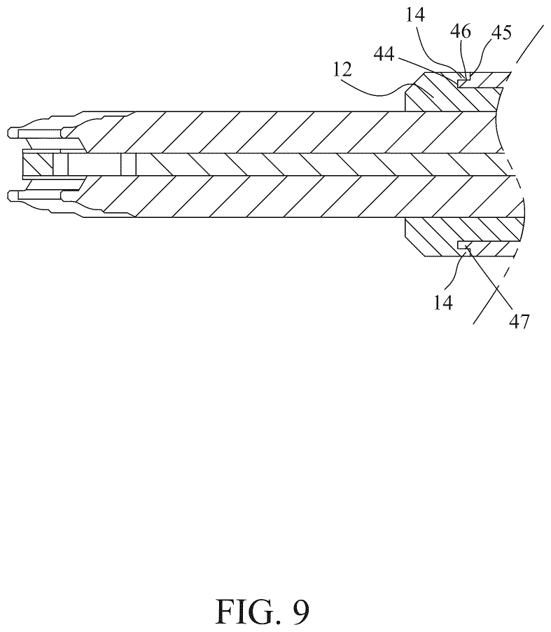

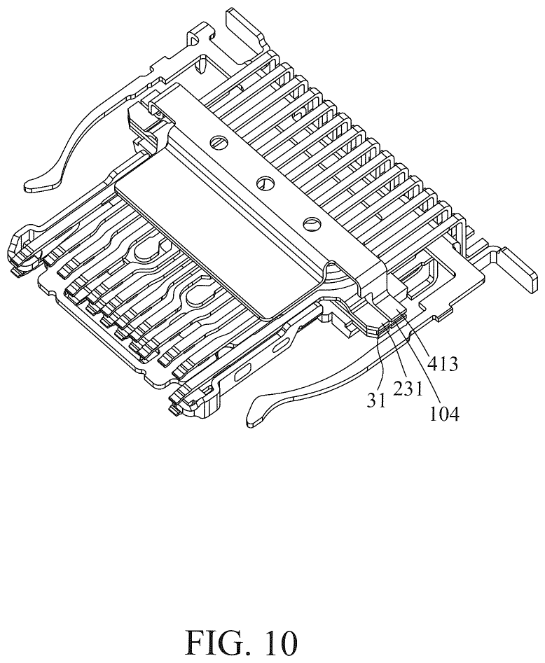

Referring to FIG. 1 to FIG. 10, the terminal assembly 2 is disposed in the insulation body 1. The terminal assembly 2 includes an upper terminal assembly 21 fastened in an upper portion of the insulation body 1, and a lower terminal assembly 22 fastened in a lower portion of the insulation body 1. The upper terminal assembly 21 is disposed on a top surface of the middle grounding plate 3. The lower terminal assembly 22 is disposed under a bottom surface of the middle grounding plate 3. The upper terminal assembly 21 and the lower terminal assembly 22 are disposed opposite to each other. The middle grounding plate 3 is disposed between the upper terminal assembly 21 and the lower terminal assembly 22. The upper terminal assembly 21, the lower terminal assembly 22 and the middle grounding plate 3 are fastened in the insulation body 1.

The terminal assembly 2 includes a base portion 202, and a plurality of terminals 201 fastened in the base portion 202. The upper terminal assembly 21 includes a plurality of upper terminals 211 and an upper base portion 212. The plurality of the upper terminals 211 are fastened in the upper base portion 212. The lower terminal assembly 22 includes a plurality of lower terminals 221 and a lower base portion 222. The plurality of the lower terminals 221 are fastened in the lower base portion 222. The base portion 202 includes the upper base portion 212 and the lower base portion 222. The plurality of the terminals 201 include the plurality of the upper terminals 211 and the plurality of the lower terminals 221. The plurality of the upper terminals 211 and the plurality of the lower terminals 221 are arranged in two rows and along an up-down direction.

Each terminal 201 has a fastening portion 213, a contacting portion 214 and a soldering portion 215. A front end of the fastening portion 213 extends frontward to form the contacting portion 214. A rear end of the fastening portion 213 extends downward, and then is bent rearward to form the soldering portion 215.

The plurality of the terminals 201 are arranged in the two rows and along the up-down direction. Two outer sides of the plurality of the terminals 201 arranged in each row include two grounding terminals 23, two power terminals 24 and a plurality of signal terminals 25. The USB Type-C connector has twelve pins. The twelve pins are defined as a first pin, a second pin, a third pin, a fourth pin, a fifth pin, a sixth pin, a seventh pin, an eighth pin, a ninth pin, a tenth pin, an eleventh pin and a twelfth pin. The twelve pins are a grounding terminal 23, a signal terminal 25, the signal terminal 25, a power terminal 24, the signal terminal 25, the signal terminal 25, the signal terminal 25, the signal terminal 25, the power terminal 24, the signal terminal 25, the signal terminal 25 and the grounding terminal 23 which are transversely arranged in sequence.

Each grounding terminal 23 has the fastening portion 213, a grounding foot 231, a chamfer 232, an arc portion 233 and a notch 234. A middle of an outer side of the fastening portion 213 of each grounding terminal 23 extends outward, then is bent outward and extends outward to form the grounding foot 231. An outer surface of the arc portion 233 extends outward, then is bent outward and extends outward to form the grounding foot 231. The grounding foot 231 is shown as a Z shape. The grounding foot 231 is surrounded by the base body 11 of the insulation body 1. The grounding foot 231 is fastened to a corresponding mechanism of the middle grounding plate 3 to realize that the terminal assembly 2 is located to the middle grounding plate 3, and the terminal assembly 2 is fixed to the middle grounding plate 3. A junction between a front surface and an outer surface of the grounding foot 231 has the chamfer 232 slantwise extending rearward and outward. The chamfer 232 is used for increasing an area of the base body 11 of the insulation body 1 to avoid a short shot problem of the insulation body 1.

A middle of the fastening portion 213 of each grounding terminal 23 is bent inward and frontward to form the arc portion 233. The outer surface of the arc portion 233 extends outward to form the grounding foot 231. The arc portion 233 facilitates a terminal shape formation of each grounding terminal 23 of the terminal assembly 2. An outer surface of a junction between the arc portion 233 and the fastening portion 213 of each grounding terminal 23 is recessed inward to form the notch 234. The grounding feet 231 of the grounding terminals 23 of the terminal assembly 2 are located in front of the notches 234 of the grounding terminals 23 of the terminal assembly 2. A corresponding mechanism of the base portion 202 is filled in the notch 234. The notch 234 is used for increasing an area of the base portion 202 of the terminal assembly 2 to avoid the short shot problem of the base portion 202 of the terminal assembly 2.

A middle of the fastening portion 213 of each power terminal 24 slantwise extends frontward and inward to form an inclining portion 241. A position of the inclining portion 241 of each power terminal 24 is corresponding to a position of the arc portion 233 of one grounding terminal 23 along a transverse direction. The inclining portion 241 facilitates the terminal shape formation of each power terminal 24 of the terminal assembly 2.

Two adjacent signal terminals 25 of each row of the plurality of the terminals 201 of the terminal assembly 2 are disposed between the one grounding terminal 23 and one power terminal 24. A middle of the fastening portion 213 of each signal terminal 25 which is located between the one grounding terminal 23 and the one power terminal 24 is bent inward and frontward to form a bending piece 251. The bending piece 251 of each signal terminal 25 which is located between the one grounding terminal 23 and the one power terminal 24 is corresponding to the arc portion 233 of the one grounding terminal 23. The bending pieces 251 of the signal terminals 25 which are located between the one grounding terminal 23 and the one power terminal 24 facilitate the terminal shape formations of the signal terminals 25 which are located between the one grounding terminal 23 and the one power terminal 24 of the terminal assembly 2.

A first gap 101 is formed between the arc portion 233 of the grounding terminal 23 and the bending piece 251 of the signal terminal 25 which are adjacent to each other. A second gap 102 is formed between the inclining portion 241 of the power terminal 24 and the bending piece 251 of the signal terminal 25 which are adjacent to each other. A third gap 103 is formed between the bending pieces 251 of the two adjacent signal terminals 25 of each row of the plurality of the terminals 201. Therefore, the first gap 101 is equal to the second gap 102. The second gap 102 is equal to the third gap 103. The third gap 103 is equal to the first gap 101. The first gap 101, the second gap 102 and the third gap 103 are used for improving an impedance of the electrical connector 100.

The plurality of the upper terminals 211 are defined as the one row of the terminals 201. Two outer sides of the plurality of the upper terminals 211 include the two grounding terminals 23. Each upper terminal 211 has an upper fastening portion 216, an upper contacting portion 217 extended frontward from a front end of the upper fastening portion 216, and an upper soldering portion 218 bent downward, and then bent rearward from a rear end of the upper fastening portion 216.

The plurality of the lower terminals 221 are defined as the other row of the terminals 201. Two outer sides of the plurality of the lower terminals 221 include the two grounding terminals 23. Each lower terminal 221 has a lower fastening portion 223, a lower contacting portion 224 extended frontward from a front end of the lower fastening portion 223, and a lower soldering portion 225 bent downward, and then bent frontward from a rear end of the lower fastening portion 223.

The fastening portion 213 includes the upper fastening portion 216 and the lower fastening portion 223. The contacting portion 214 includes the upper contacting portion 217 and the lower contacting portion 224. The soldering portion 215 includes the upper soldering portion 218 and the lower soldering portion 225.

The base portion 202 has a main body 2121, a connecting portion 2122 and a tongue portion 2123. The tongue portion 2123 projects beyond a front surface of the enclosing portion 12. The notch 234 of each grounding terminal 23 is filled by the main body 2121 of the base portion 202. Specifically, the notches 234 of the grounding terminals 23 of the upper terminal assembly 21 and the lower terminal assembly 22 are filled by the upper base portion 212 and the lower base portion 222. A middle of a front end of the main body 2121 extends frontward to form the connecting portion 2122. A front end of the connecting portion 2122 extends frontward to form the tongue portion 2123. The fastening portions 213 of the plurality of the terminals 201 are fastened in the main body 2121 and the connecting portion 2122 of the base portion 202, and the fastening portions 213 of the plurality of the terminals 201 are partially surrounded by the main body 2121 and the connecting portion 2122 of the base portion 202. Top surfaces of the fastening portions 213 of the one row of the terminals 201 are exposed to a top surface of the connecting portion 2122. Bottom surfaces of the fastening portions 213 of the other row of the terminals 201 are exposed to a bottom surface of the connecting portion 2122. The contacting portions 214 of the plurality of the terminals 201 are fastened in the tongue portion 2123 of the base portion 202, and the contacting portions 214 of the plurality of the terminals 211 are partially surrounded by the tongue portion 2123 of the base portion 202. Top surfaces of the contacting portions 214 of the one row of the terminals 201 are exposed to a top surface of the tongue portion 2123. Bottom surfaces of the contacting portions 214 of the other row of the terminals 201 are exposed to a bottom surface of the tongue portion 2123. The soldering portions 215 of the plurality of the terminals 201 project beyond a rear surface of the main body 2121 of the base portion 202.

The main body 2121 of the base portion 202 is disposed in the base body 11 of the insulation body 1. Each of a top surface and a bottom surface of the main body 2121 extends outward to form a location block 2124. Specifically, each of the top surface and the bottom surface of the main body 2121 has two location blocks 2124 disposed transversely. The location blocks 2124 of the main body 2121 are disposed in the base body 11 of the insulation body 1. The location blocks 2124 of the main body 2121 of the base portion 202 of the terminal assembly 2 are fastened in the corresponding mechanisms of the two shielding plates 4 to realize that the two shielding plates 4 are located to the terminal assembly 2, and the two shielding plates 4 are fixed to the terminal assembly 2. Two middles of two opposite sides surfaces of the base portion 202 extend outward to form two protruding portions 2125, respectively. Two opposite sides of the front end of the main body 2121 extend outward to form the two protruding portions 2125. The grounding feet 231 of the grounding terminals 23 of the upper terminal assembly 21 and the lower terminal assembly 22 of the terminal assembly 2 are partially surrounded by the two protruding portions 2125. The two middles of the two opposite sides surfaces of the base portion 202 are recessed inward to form two lacking grooves 2126, respectively. Two opposite sides of a middle of the main body 2121 are recessed inward to form two lacking grooves 2126. The two protruding portions 2125 are located in front of the two lacking grooves 2126. The two lacking grooves 2126 are located between the two protruding portions 2125 and a rear end of the main body 2121. Corresponding sections of the two shielding plates 4 are corresponding to the two lacking grooves 2126.

The connecting portion 2122 of the base portion 202 is disposed in the enclosing portion 12 of the insulation body 1. Several portions of a top surface of the connecting portion 2122 extend outward to form a plurality of supporting portions 2127. The plurality of the supporting portions 2127 are disposed in the plurality of the through holes 13 of the insulation body 1. When the insulation body 1 is formed, the plurality of the supporting portions 2127 are used for supporting corresponding areas of the two shielding plates 4 to avoid the encapsulation problem of the two shielding plates 4.

The upper base portion 212 has an upper main body 203, an upper connecting portion 204 and an upper tongue portion 205. The upper connecting portion 204 of the upper base portion 212 is disposed in the enclosing portion 12 of the insulation body 1. The upper tongue portion 205 projects beyond the front surface of the enclosing portion 12. A middle of a front end of the upper main body 203 extends frontward to form the upper connecting portion 204. A front end of the upper connecting portion 204 extends frontward to form the upper tongue portion 205. The upper fastening portions 216 of the plurality of the upper terminals 211 are fastened in the upper main body 203 and the upper connecting portion 204 of the upper base portion 212, and the upper fastening portions 216 of the plurality of the upper terminals 211 are partially surrounded by the upper main body 203 and the upper connecting portion 204 of the upper base portion 212. Top surfaces of the upper fastening portions 216 of the plurality of the upper terminals 211 are exposed to a top surface of the upper connecting portion 204. The upper contacting portions 217 of the plurality of the upper terminals 211 are fastened in the upper tongue portion 205 of the upper base portion 212, and the upper contacting portions 217 of the plurality of the upper terminals 211 are partially surrounded by the upper tongue portion 205 of the upper base portion 212. Top surfaces of the upper contacting portions 217 of the plurality of the upper terminals 211 are exposed to a top surface of the upper tongue portion 205. The upper soldering portions 218 of the plurality of the upper terminals 211 are exposed to a lower portion of a rear end of the upper main body 203 of the upper base portion 212.

The lower base portion 222 has a lower main body 206, a lower connecting portion 207 and a lower tongue portion 208. The lower connecting portion 207 of the lower base portion 222 is disposed in the enclosing portion 12 of the insulation body 1. The lower tongue portion 208 projects beyond the front surface of the enclosing portion 12. A middle of a front end of the lower main body 206 extends frontward to form the lower connecting portion 207. A front end of the lower connecting portion 207 extends frontward to form the lower tongue portion 208. The lower fastening portions 223 of the plurality of the lower terminals 221 are fastened in the lower main body 206 and the lower connecting portion 207 of the lower base portion 222, and the lower fastening portions 223 of the plurality of the lower terminals 221 are partially surrounded by the lower main body 206 and the lower connecting portion 207 of the lower base portion 222. Bottom surfaces of the lower fastening portions 223 of the plurality of the lower terminals 221 are exposed to a bottom surface of the lower connecting portion 207. The lower contacting portions 224 of the plurality of the lower terminals 221 are fastened in the lower tongue portion 208 of the lower base portion 222, and the lower contacting portions 224 of the plurality of the lower terminals 221 are partially surrounded by the lower tongue portion 208 of the lower base portion 222. Bottom surfaces of the lower contacting portions 224 of the plurality of the lower terminals 221 are exposed to a bottom surface of the lower tongue portion 208. The lower soldering portions 225 of the plurality of the lower terminals 221 are exposed to a lower portion of a rear end of the lower main body 206 of the lower base portion 222.

Referring to FIG. 3, two opposite sides of a middle of the middle grounding plate 3 extend outward to form two wings 31, respectively. The grounding feet 231 of the grounding terminals 23 of the terminal assembly 2 are connected to front ends of top surfaces and bottom surfaces of the two wings 31. The grounding feet 231 of the grounding terminals 23 of the terminal assembly 2 are soldered to the front ends of the top surfaces and the bottom surfaces of the two wings 31 of the middle grounding plate 3, so that the middle grounding plate 3 is located in the terminal assembly 2 to be fixed to the terminal assembly 2, and a crosstalk interference of the electrical connector 100 is improved. Specifically, the grounding feet 231 of the grounding terminals 23 of the upper terminal assembly 21 are soldered to the front ends of the top surfaces of the two wings 31, and the grounding feet 231 of the grounding terminals 23 of the lower terminal assembly 22 are soldered to the front ends of the bottom surfaces of the two wings 31.

Referring to FIG. 3 to FIG. 9, each shielding plate 4 has a base plate 41, an extending plate 42, an exterior surface 43, a front surface 44 and a stepping portion 47. The base plate 41 is disposed in the base body 11 of the insulation body 1. A middle of a front edge of the base plate 41 extends frontward to form the extending plate 42. The extending plate 42 is exposed out of an outer surface of the enclosing portion 12 of the insulation body 1. The plurality of the supporting portions 2127 are disposed to two inner surfaces of the two extending plates 42 of the two shielding plates 4. The extending plate 42 has the exterior surface 43, the front surface 44 and the stepping portion 47. A front end of the exterior surface 43 is recessed downward to form the stepping portion 47. An upper portion of the stepping portion 47 is connected with a rear end of a top surface of a lower portion of the stepping portion 47. A top edge of the front surface 44 is located in front of the upper portion of the stepping portion 47. The stepping portion 47 has a first surface 45 and a second surface 46. A front surface of the upper portion of the stepping portion 47 forms the first surface 45 extending downward. A top edge of the first surface 45 is connected with the exterior surface 43. A bottom edge of the first surface 45 extends frontward to form the second surface 46. A front edge of the second surface 46 is connected with the top edge of the front surface 44.

Two fronts of two outer surfaces of the insulation body 1 protrude outward and then extend rearward to form two stepping blocks 14. Two top surfaces of the two stepping blocks 14 of the insulation body 1 are flush with the two exterior surfaces 43 of the two shielding plates 4. Two outer portions of the two stepping blocks 14 are protruded outward from two outer surfaces of two inner portions of the two stepping blocks 14 and project beyond two rear surfaces of the two inner portions of the two stepping blocks 14. The outer portion of each stepping block 14 is embedded between the first surface 45 and the second surface 46 of one stepping portion 47. The rear surfaces of the two inner portions of the two stepping blocks 14 abut against the two front surfaces 44 of the two stepping portions 47. Specifically, two middles of the two outer surfaces of the insulation body 1 are recessed inward to form two limiting grooves 105 extending to the two rear surfaces of the two inner portions of the two stepping blocks 14. The two outer portions of the two stepping blocks 14 block two fronts of two outer portions of the two limiting grooves 105.

The two stepping portions 47 are matched with the two stepping blocks 14. The first surface 45 of each stepping portion 47 abuts against a rear surface of the outer portion of one stepping block 14. The second surface 46 of each stepping portion 47 is filled in the one stepping block 14. The second surface 46 of each stepping portion 47 abuts against an inner surface of the outer portion of the one stepping block 14. The two shielding plates 4 are surrounded by the two stepping blocks 14 of the insulation body 1. The two stepping portions 47 are filled with the two stepping blocks 14 of the insulation body 1, so the two stepping portions 47 of the two shielding plates 4 are disposed in the insulation body 1. The two stepping portions 47 of the two shielding plates 4 are surrounded by the two stepping blocks 14 of the insulation body 1 to prevent the two shielding plates 4 from tilting upward and warping. The two front surfaces 44 of the two shielding plates 4 are surrounded by the two stepping blocks 14 of the insulation body 1 to prevent the two front surfaces 44 from being exposed out of the enclosing portion 12 of the insulation body 1. Two outer surfaces of the two stepping blocks 14 of the insulation body 1 are flush with the two exterior surfaces 43 of the two shielding plates 4, so that a function and a structure of the electrical connector 100 are prevented.

The base plate 41 has a plurality of location holes 411, two bending portions 412 and two soldering plates 413. The base plate 41 of each shielding plate 4 defines the plurality of the location holes 411 vertically penetrating through the base plate 41. The plurality of the location blocks 2124 of the terminal assembly 2 are fastened in the plurality of the location holes 411 to realize that the two shielding plates 4 are located to the terminal assembly 2, and the two shielding plates 4 are fixed to the terminal assembly 2. Two opposite sides of a rear end of each shielding plate 4 are bent inward to form the two bending portions 412, respectively. Two opposite sides of the base plate 41 of each shielding plate 4 are bent inward to form the two bending portions 412, respectively. The bending portions 412 of the two shielding plates 4 are disposed in the two lacking grooves 2126 of the terminal assembly 2.

Two opposite sides of the two bending portions 412 extend outward to form the two soldering plates 413, respectively. The soldering plates 413 of the two shielding plates 4 are connected to rear ends of the top surfaces and the bottom surfaces of the two wings 31. The soldering plates 413 of the two shielding plates 4 are soldered to the rear ends of the top surfaces and the bottom surfaces of the two wings 31 of the middle grounding plate 3, so that the crosstalk interference of the electrical connector 100 is improved. The soldering plates 413 of the two shielding plates 4 are corresponding to the two lacking grooves 2126. The grounding feet 231 of the grounding terminals 23 of the terminal assembly 2 are disposed in front of the soldering plates 413 of the two shielding plates 4. In the concrete implementation, the grounding feet 231 of the grounding terminals 23 of the terminal assembly 2 are without being limited to be disposed in front of the soldering plates 413 of the two shielding plates 4.

Referring to FIG. 2 to FIG. 10, the two grounding feet 231 of the two grounding terminals 23 of each row of the plurality of the terminals 201 are disposed in front of the two soldering plates 413 of one shielding plate 4. Outer edges of the grounding feet 231 of the grounding terminals 23 of the upper terminal assembly 21 and the lower terminal assembly 22 of the terminal assembly 2 project beyond two outer edges of the two wings 31 of the middle grounding plate 3, and outer edges of the soldering plates 413 of the two shielding plates 4 project beyond the two outer edges of the two wings 31 of the middle grounding plate 3, so the two outer edges of the two grounding feet 231 of the two grounding terminals 23, the two outer edges of the two soldering plates 413 of the two shielding plates 4 and the outer edge of the wing 31 of the middle grounding plate 3 which are located to each side of the middle grounding plate 3 surround an indentation 104. The indentation 104 is filled by the insulation body 1 to improve a plastic combining force.

As described above, the grounding feet 231 of the grounding terminals 23 of the terminal assembly 2 are soldered to the front ends of the top surfaces and the bottom surfaces of the two wings 31 of the middle grounding plate 3, and the soldering plates 413 of the two shielding plates 4 are soldered to the rear ends of the top surfaces and the bottom surfaces of the two wings 31 of the middle grounding plate 3, so that the crosstalk interference of the electrical connector 100 is improved. Furthermore, the arc portion 233 facilitates the terminal shape formation of each grounding terminal 23 of the terminal assembly 2, the inclining portion 241 facilitates the terminal shape formation of each power terminal 24 of the terminal assembly 2, and the bending pieces 251 of the signal terminals 25 which are located between the one grounding terminal 23 and the one power terminal 24 facilitate the terminal shape formations of the signal terminals 25 which are located between the one grounding terminal 23 and the one power terminal 24 of the terminal assembly 2. In addition, the chamfer 232 is used for increasing the area of the base body 11 of the insulation body 1 to avoid the short shot problem of the insulation body 1, and the notch 234 is used for increasing the area of the base portion 202 of the terminal assembly 2 to avoid the short shot problem of the base portion 202 of the terminal assembly 2. The indentation 104 is filled by the insulation body 1 to improve the plastic combining force. As a result, the electrical connector 100 is capable of improving the plastic combining force, improving the crosstalk interference and shaping the terminal 201 conveniently.

What is claimed is:

1. An electrical connector, comprising:
an insulation body;
a terminal assembly fastened in the insulation body, the terminal assembly having a base portion, and a plurality of terminals fastened in the base portion, the plurality of the terminals being arranged in two rows and along an up-down direction, the plurality of the terminals arranged in each row having two grounding terminals, each grounding terminal having a fastening portion, a middle of the fastening portion of each grounding terminal being bent inward and frontward to form an arc portion, an outer surface of the arc portion extending outward, then being bent outward and extending outward to form a grounding foot, an outer surface of a junction between the arc portion and the fastening portion of each grounding terminal being recessed inward to form a notch, the notch of each grounding terminal being filled by the base portion;
a middle grounding plate mounted in a middle of the terminal assembly, and the terminal assembly and the middle grounding plate being fastened in the insulation body, two opposite sides of a middle of the middle grounding plate extending outward to form two wings, respectively, the grounding feet of the grounding terminals of the terminal assembly being soldered to front ends of top surfaces and bottom surfaces of the two wings; and
two shielding plates disposed to an upper surface and a lower surface of the insulation body, two opposite sides of a rear end of each shielding plate being bent inward to form two bending portions, respectively, two opposite sides of the two bending portions extending outward to form two soldering plates, respectively, the soldering plates of the two shielding plates being soldered to rear ends of the top surfaces and the bottom surfaces of the two wings.

2. The electrical connector as claimed in claim 1, wherein the base portion has a main body, the notch of each grounding terminal is filled by the main body of the base portion, two opposite sides of a front end of the main body extend outward to form two protruding portions, the grounding feet of the grounding terminals of the terminal assembly are partially surrounded by the two protruding portions.

3. The electrical connector as claimed in claim 2, wherein two opposite sides of a middle of the main body are recessed inward to form two lacking grooves, the two lacking grooves are located between the two protruding portions and a front end of the main body, the bending portions of the two shielding plates are disposed in the two lacking grooves, the soldering plates of the two shielding plates are corresponding to the two lacking grooves.

4. The electrical connector as claimed in claim 1, wherein the plurality of the terminals arranged in each row have two power terminals and a plurality of signal terminals, a middle of the fastening portion of each power terminal slantwise extends frontward and inward to form an inclining portion, a position of the inclining portion of each power terminal is corresponding to a position of the arc portion of one grounding terminal along a transverse direction, two adjacent signal terminals of each row of the plurality of the terminals are disposed between the one grounding terminal and one power terminal, a middle of the fastening portion of each signal terminal which is located between the one grounding terminal and the one power terminal is bent inward and frontward to form a bending piece, the bending piece of each signal terminal which is located between the one grounding terminal and the one power terminal is corresponding to the arc portion of the one grounding terminal.

5. The electrical connector as claimed in claim 4, wherein a first gap is formed between the arc portion of the grounding terminal and the bending piece of the signal terminal which are adjacent to each other, a second gap is formed between the inclining portion of the power terminal and the bending piece of the signal terminal which are adjacent to each other, a third gap is formed between the bending pieces of the two adjacent signal terminals of each row of the plurality of the terminals, the first gap is equal to the second gap, the second gap is equal to the third gap, the third gap is equal to the first gap.

6. The electrical connector as claimed in claim 1, wherein the insulation body has a base body, a front surface of the base body extends frontward to form an enclosing portion, each shielding plate has a base plate and an extending plate, the base plate is disposed in the base body, a middle of a front edge of the base plate extends frontward to form the extending plate, the extending plate is exposed out of an outer surface of the enclosing portion of the insulation body, two opposite sides of the base plate of each shielding plate are bent inward to form the two bending portions, respectively, the two opposite sides of the two bending portions extend outward to form the two soldering plates, respectively.

7. The electrical connector as claimed in claim 6, wherein the extending plate has an exterior surface, a front surface and a stepping portion, a front end of the exterior surface is recessed downward to form the stepping portion, an upper portion of the stepping portion is connected with a rear end of a top surface of a lower portion of the stepping portion, a top edge of the front surface is located in front of the upper portion of the stepping portion, two fronts of two outer surfaces of the insulation body protrude outward and then extend rearward to form two stepping blocks, the two front surfaces of the two shielding plates are surrounded by the two stepping blocks of the insulation body, two top surfaces of the two stepping blocks of the insulation body are flush with the two exterior surfaces of the two shielding plates, the two stepping portions are filled with the two stepping blocks of the insulation body, the stepping portion has a first surface and a second surface, a front surface of the upper portion of the stepping portion forms the first surface extending downward, a top edge of the first surface is connected with the exterior surface, a bottom edge of the first surface extends frontward to form the second surface, a front edge of the second surface is connected with the top edge of the front surface.

8. The electrical connector as claimed in claim 1, wherein the grounding feet of the grounding terminals of the terminal assembly are located in front of the notches of the grounding terminals of the terminal assembly.

9. The electrical connector as claimed in claim 1, wherein the grounding foot is shown as a Z shape.

10. An electrical connector, comprising:
an insulation body;
a terminal assembly fastened in the insulation body, the terminal assembly having:
a base portion; and
a plurality of terminals fastened in the base portion, the plurality of the terminals being arranged in two rows and along an up-down direction, two outer sides of the plurality of the terminals arranged in each row having two grounding terminals, each grounding terminal having a fastening portion, a middle of the fastening portion of each grounding terminal being bent inward and frontward to form an arc portion, an outer surface of the arc portion extending outward, then being bent outward and extending outward to form a grounding foot, a junction between a front surface and an outer surface of the grounding foot having a chamfer slantwise extending rearward and outward, an outer surface of a junction between the arc portion and the fastening portion of each grounding terminal being recessed inward to form a notch, the notch of each grounding terminal being filled by the base portion;
a middle grounding plate mounted in a middle of the terminal assembly, and the terminal assembly and the middle grounding plate being fastened in the insulation body, two opposite sides of a middle of the middle grounding plate extending outward to form two wings, respectively, the grounding feet of the grounding terminals of the terminal assembly being connected to front ends of top surfaces and bottom surfaces of the two wings; and
two shielding plates disposed to an upper surface and a lower surface of the insulation body, two opposite sides of a rear end of each shielding plate being bent inward to form two bending portions, respectively, two opposite sides of the two bending portions extending outward to form two soldering plates, respectively, the soldering plates of the two shielding plates being connected to rear ends of the top surfaces and the bottom surfaces of the two wings.

11. The electrical connector as claimed in claim 10, wherein the base portion has a main body, the notch of each grounding terminal is filled by the main body of the base portion, two opposite sides of a front end of the main body extend outward to form two protruding portions, the grounding feet of the grounding terminals of the terminal assembly are partially surrounded by the two protruding portions.

12. The electrical connector as claimed in claim 10, wherein the plurality of the terminals arranged in each row have two power terminals and a plurality of signal terminals, a middle of the fastening portion of each power terminal slantwise extends frontward and inward to form an inclining portion, a position of the inclining portion of each power terminal is corresponding to a position of the arc portion of one grounding terminal along a transverse direction, two adjacent signal terminals of each row of the plurality of the terminals are disposed between the one grounding terminal and one power terminal, a middle of the fastening portion of each signal terminal which is located between the one grounding terminal and the one power terminal is bent inward and frontward to form a bending piece, the bending piece of each signal terminal which is located between the one grounding terminal and the one power terminal is corresponding to the arc portion of the one grounding terminal.

13. The electrical connector as claimed in claim 12, wherein a first gap is formed between the arc portion of the grounding terminal and the bending piece of the signal terminal which are adjacent to each other, a second gap is formed between the inclining portion of the power terminal and the bending piece of the signal terminal which are adjacent to each other, a third gap is formed between the bending pieces of the two adjacent signal terminals of each row of the plurality of the terminals, the first gap is equal to the second gap, the second gap is equal to the third gap, the third gap is equal to the first gap.

14. The electrical connector as claimed in claim 10, wherein the insulation body has a base body, a front surface of the base body extends frontward to form an enclosing portion, each shielding plate has a base plate and an extending plate, the base plate is disposed in the base body, a middle of a front edge of the base plate extends frontward to form the extending plate, the extending plate is exposed out of an outer surface of the enclosing portion of the insulation body, two opposite sides of the base plate of each shielding plate are bent inward to form the two bending portions, respectively, the two opposite sides of the two bending portions extend outward to form the two soldering plates, respectively.

15. The electrical connector as claimed in claim 14, wherein the extending plate has an exterior surface, a front surface and a stepping portion, a front end of the exterior surface is recessed downward to form the stepping portion, an upper portion of the stepping portion is connected with a rear end of a top surface of a lower portion of the stepping portion, a top edge of the front surface is located in front of the upper portion of the stepping portion, two fronts of two outer surfaces of the insulation body protrude outward and then extend rearward to form two stepping blocks, the two front surfaces of the two shielding plates are surrounded by the two stepping blocks of the insulation body, two top surfaces of the two stepping blocks of the insulation body are flush with the two exterior surfaces of the two shielding plates, the two stepping portions are filled with the two stepping blocks of the insulation body, the stepping portion has a first surface and a second surface, a front surface of the upper portion of the stepping portion forms the first surface extending downward, a top edge of the first surface is connected with the exterior surface, a bottom edge of the first surface extends frontward to form the second surface, a front edge of the second surface is connected with the top edge of the front surface.

16. The electrical connector as claimed in claim 10, wherein outer edges of the grounding feet of the grounding terminals of the terminal assembly project beyond two outer edges of the two wings, and outer edges of the soldering plates of the two shielding plates project beyond the two outer edges of the two wings, so the two outer edges of the two grounding feet of the two grounding terminals, the two outer edges of the two soldering plates of the two shielding plates and the outer edge of the wing of the middle grounding plate which are located to each side of the middle grounding plate surround an indentation, the indentation is filled by the insulation body.

17. An electrical connector, comprising:
an insulation body;
an upper terminal assembly fastened in an upper portion of the insulation body, the upper terminal assembly having a plurality of upper terminals and an upper base portion, the plurality of the upper terminals being fastened in the upper base portion, two outer sides of the plurality of the upper terminals having two grounding terminals;
a lower terminal assembly fastened in a lower portion of the insulation body, the lower terminal assembly having a plurality of lower terminals and a lower base portion, the plurality of the lower terminals being fastened in the lower base portion, two outer sides of the plurality of the lower terminals having the two grounding terminals, each grounding terminal having a fastening portion, a middle of the fastening portion of each grounding terminal being bent inward and frontward to form an arc portion, an outer surface of the arc portion extending outward, then being bent outward and extending outward to form a grounding foot, an outer surface of a junction between the arc portion and the fastening portion of each grounding terminal being recessed inward to form a notch, the notches of the grounding terminals of the upper terminal assembly and the lower terminal assembly being filled by the upper base portion and the lower base portion;
a middle grounding plate disposed between the upper terminal assembly and the lower terminal assembly, the upper terminal assembly, the lower terminal assembly and the middle grounding plate being fastened in the insulation body, two opposite sides of a middle of the middle grounding plate extending outward to form two wings, respectively, the grounding feet of the grounding terminals of the upper terminal assembly being soldered to front ends of top surfaces of the two wings, and the grounding feet of the grounding terminals of the lower terminal assembly being soldered to front ends of bottom surfaces of the two wings; and
two shielding plates disposed to an upper surface and a lower surface of the insulation body, two opposite sides of a rear end of each shielding plate being bent inward to form two bending portions, respectively, two opposite sides of the two bending portions extending outward to form two soldering plates, respectively, the soldering plates of the two shielding plates being soldered to rear ends of the top surfaces and the bottom surfaces of the two wings;
wherein outer edges of the grounding feet of the grounding terminals of the upper terminal assembly and lower terminal assembly project beyond two outer edges of the two wings, and outer edges of the soldering plates of the two shielding plates project beyond the two outer edges of the two wings of the middle grounding plate.

18. The electrical connector as claimed in claim 17, wherein the upper terminal assembly and the lower terminal assembly are assembled into a terminal assembly fastened in the insulation body, the terminal assembly having a base portion, the base portion having an upper base portion and a lower base portion, the base portion having a main body, the notch of each grounding terminal being filled by the main body of the base portion, two opposite sides of a front end of the main body extending outward to form two protruding portions, the grounding feet of the grounding terminals of the upper terminal assembly and the lower terminal assembly being partially surrounded by the two protruding portions.

19. The electrical connector as claimed in claim 17, wherein a junction between a front surface and an outer surface of the grounding foot has a chamfer slantwise extending rearward and outward.
